(19) United States
(12) Patent Application Publication
(10) Pub. No.: US 2015/0134560 A1
(43) Pub. Date: May 14, 2015

(54) METHOD FOR RECOMMENDING PREFERRED LOCATIONS FOR SHIPPING PRODUCTS AND A DISTRIBUTED NETWORKING THEREOF

(71) Applicant: Sumana Krishnaiahsetty BATCHU, (US)

(72) Inventor: Sumana Batchu Krishnaiahsetty, Bangalore (IN)

(21) Appl. No.: 14/402,994

(22) PCT Filed: May 24, 2013
(86) PCT No.: PCT/IB2013/054297

§ 371 Date: Nov. 21, 2014

(30) Foreign Application Priority Data
May 24, 2012 (GB) 1209168.2

(51) Int. Cl. G06Q 10/08

(52) U.S. Cl. CPC G06Q 10/08355
USPC 705/338

(57) ABSTRACT

The present disclosure relates to method and system to recommend locations for shipping products in an ecommerce system. In an embodiment of transaction between business entity and individual, the preferred shipping locations of a service provider are matched with that of the consumer, sorted based on finding a match and based on location proximity and then recommended as possible alternative shipping locations with lesser cost. The method of the present disclosure results in lesser shipping charges for both the consumer and the service provider.

### BACKGROUND

1. Technical Field

The present disclosure relates to a distributed networking system. In particular, the present disclosure relates to method and system to recommend preferred locations for shipping products in an e-commerce system.

2. Description of the Related Art

With the wide spread acceptance of the Internet as a ubiquitous, interactive communication and interaction platform, on-line commerce conducted over the Internet has become commonplace in a variety of business environments. On-line commerce is traditionally categorized as business-to-business (B2B), business-to-consumer (B2C), consumer-to-consumer (C2C). In the B2C and C2C environments, a number of exchanges and auction facilities have proved popular.

With increasing number of online transactions, there is a growing need to optimize on the shipping costs. In many cases, online transactions are not viable because of the disproportionate cost of shipment compared to the cost of the item transacted. This is especially true of transactions involving used goods. Optimising on shipping costs will reduce fuel consumption and enable more recycling, when the transacted item is used. This results in greener and cheaper transactions, benefiting the environment.

Therefore, there is a need to facilitate C2C and B2C transactions that can optimize on shipping costs to overcome the above-mentioned problems.

### SUMMARY

The shortcomings of the prior art are overcome and many additional advantages are provided through the present disclosure. Additional features and advantages are realized through the techniques of the present disclosure. Other embodiments and aspects of the disclosure are described in detail herein and are considered a part of the claimed disclosure.

In one embodiment, the present disclosure relates to a method for recommending one or more locations for shipping products to a consumer of a transaction in a distributed networking system. The method comprises retrieving one or more preferred locations by a processing unit configured in the transaction server from profile of the consumer stored in the storage unit for shipping products. Then, matching, by the processing unit, the retrieved preferred locations of the consumer with a list of preferred locations of the service provider of the transaction in the profile of the service provider. The list of preferred locations typically is the frequently used locations of the user. The next step involves, filtering the preferred locations of the service provider based on threshold maximum distance defined by the system. To do this, the distance between the preferred locations of the service provider and customer's default location is computed and tested to be less than the defined threshold maximum distance. The locations (except for the ones which matched with the consumer's locations), with distances greater than the threshold maximum distance are discarded at this stage. Finally, a sorted list of the preferred locations of the service provider is recommended, by the processing unit, for delivering shipments to the consumer. The sorting of the preferred locations is based on any combination of one or more of a Boolean flag indicating a match with at least one preferred location of the consumer, distance between the preferred location of the service provider and the nearest location among one or more locations of the consumer and cost of shipping to the preferred locations of the consumer. The recommended list of locations is then displayed on a suitably designed user interface on the client device.

In one embodiment, the present disclosure relates to a distributed networking system for recommending one or more locations for shipping products to a consumer of a transaction. The system comprises a transaction server connected to a plurality of client devices over a network. The transaction server comprises a storage unit to store user profile of one or more users and a processing unit, in communication with the storage unit. The processing unit is configured to retrieve one or more locations from profile of the consumer for shipping products, match the retrieved preferred locations of the consumer with a list of preferred locations of the service provider of the transaction in the profile of the service provider, wherein the list of preferred locations are the frequently used location of the user. Then, a filtered and sorted list of the preferred locations of the service provider is recommended for delivering shipments to the consumer. The filtering is based on a threshold location proximity defined by the system, and the sorting is based at least one of the preferred locations of the consumer matching the preferred locations of the service provider, the distance between the preferred location of the service provider and the nearest preferred location of the consumer and cost of shipping to a preferred location of the service provider. The plurality of client devices wherein each of the client devices comprises a user interface to display the sorted list of preferred location to the consumer.

The aforementioned and other features and advantages of the disclosure will, become further apparent from the following detailed description of the presently preferred embodiments, read in conjunction with the accompanying drawings. The detailed description and drawings are merely illustrative of the disclosure rather than limiting, the scope of the disclosure being defined by the appended claims and equivalents thereof.

### BRIEF DESCRIPTION OF THE DRAWINGS

The features of the present disclosure are set forth with particularity in the appended claims. The embodiments of the disclosure itself, together with further features and attended advantages, will become apparent from consideration of the following detailed description, taken in conjunction with the accompanying drawings. One or more embodiments of the present disclosure are now described, by way of example only, with reference to the accompanied drawings wherein like reference numerals represent like elements and in which:

FIG. 1 illustrates a distributed networking system in accordance with an embodiment of the present disclosure; and

FIG. 2 illustrates a flow-chart showing a method for recommending cost-effective locations for shipping products in accordance with an embodiment of the present disclosure;

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF PREFERRED EMBODIMENTS

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

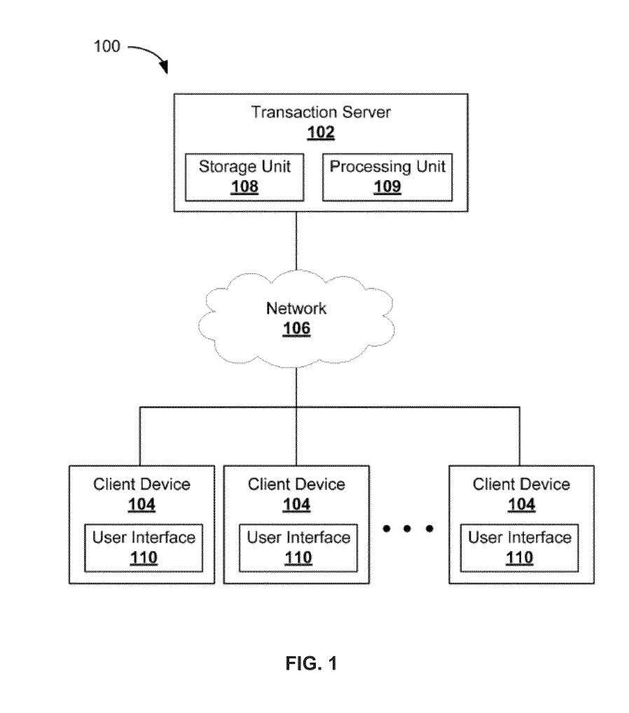

FIG. 1 illustrates a distributed networking system 100 in accordance with an embodiment of the present disclosure. In an embodiment, the distributed networking system 100 is an ecommerce system. The ecommerce system 100 has a provision for the users to perform B2C and C2C transactions between the users connected to the network. The users of the ecommerce system may include, but is not limited to individual and companies/business entities. The users of the network may take on the role of a consumer or service provider in any give transaction. The consumer requests for goods and/or services from service providers.

The system comprises a transaction server 102, a plurality of client devices 104 and a network 106 connecting the transaction server 102 to the plurality of client devices 104. The transaction server 102 comprises storage unit 108 and a processing unit 109. The client device 104 is associated with the users and comprises a user interface 110. The user interface 110 is configured to input information from one or more users connected over the ecommerce system. Also the user interface 110 is configured to display one or more information.

Each user has a profile created on the ecommerce system. The storage unit 108 is configured to store profile information of all the users connected to the network 106. The user profile comprises information about the user. One such information could be preferred location information of the user. The user can input the preferred location information as place of residence or frequently visited places into the user profile. The user also identifies one of these locations as default location. The location information can also include details of visit time, frequency of visit, and transport-mode used for visiting the location. In an exemplary embodiment, the list of frequently visited places could be places like offices, tech-parks, schools, stores, clubs, etc., where the user visits frequently.

The processing unit 109 of the transaction server 102 is configured to optimize on shipping costs in an online transaction. In an embodiment, the transaction can be Business-to-Business (B2C) or Consumer-to-Consumer (C2C). In a B2C transaction, the processing unit 109 the transaction server 102 intelligently recommends appropriate location for delivery of transacted product/item. In a C2C environment, the processing unit 109 of the transaction server 102 recommends appropriate location for users' transaction exchanges. The preferred location information stored in storage unit 108 of the transaction server 102 acts as interaction points for any C2C transactions and can also act as preferred collection-points for B2C transactions. In an exemplary embodiment, the transaction can include, but is not limiting to, sale of physical goods, barter, collection/delivery resulting from a service.

The processing unit 109 of the transaction server 102 is configured to generate a public directory of popular locations. In an embodiment, when a predetermined number of users have same preferred location information in their user profile, then processing unit 109 defines the location as popular location. In an exemplary embodiment, the predefined number of users can be 20. The popular locations have a facility to accept deliveries possibly by employing manual labour at the location. Such a facility might be provided by a third party service provider and the service provider making deliveries to such locations could be charged a fee for doing so. In an embodiment, the companies could offer shipping discounts when delivery is to a popular location. When user preferred location information in the user profile is same as one from the directory of popular location, the location is flagged in the user profile for easier identification. Also, the discounted shipping rate being offered by the user for the popular location is available in the profile information.

The processing unit 109 also recommends possible locations as popular locations. The recommendation can be based on a predefined minimum user density and maximum distance between user-locations and recommended popular location. The processing unit 109 then has the option to create the popular location based on the recommendations. In an exemplary embodiment, the recommendations would be used to identify a place including, but not limiting to, post-office, tech-park, super-market, etc., in the vicinity and designate that place as a popular location after ensuring that the place can be used to collect deliveries, possibly by renting some location facility and employing manual labour.

Also, the system of the present disclosure can recommend the popular locations as possible additions to preferred location information of user based on preconfigured as well as user editable maximum distance. This will be especially useful when a user does not have a preferred location in their location information.

The transaction server 102 can access preferred location information of all the users stored in the storage unit 108 and popular locations generated by the processing unit and recommend appropriate location for transaction exchanges between users.

In an embodiment, the user connected to the network can recommend a popular location and/or preferred location to other users of the network, particularly to those connected to the said user through the social network. This helps in faster adoption of common locations between users and subsequent evolution of popular locations.

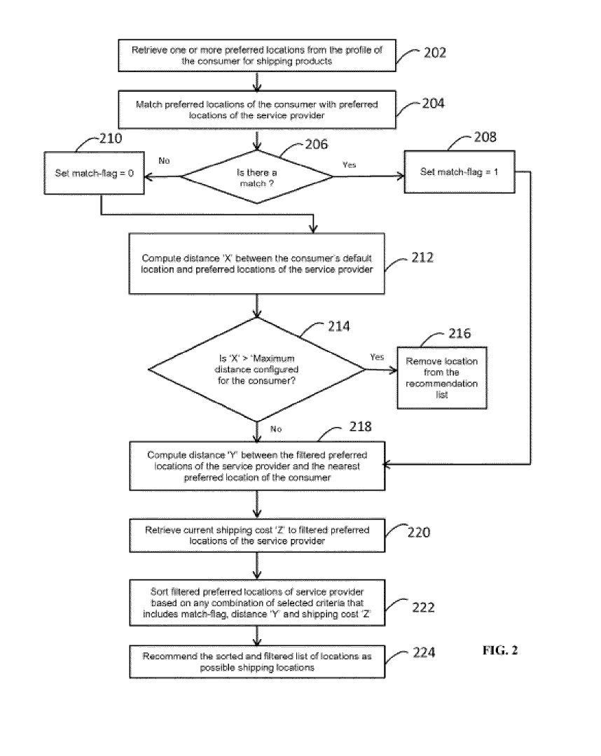

FIG. 2 illustrates a flow-chart showing a method for recommending cheaper location for shipping products in accordance with an embodiment of the present disclosure. The method comprises retrieving one or more preferred locations from profile of the consumer for shipping products of a transaction to the consumer at step 202. The retrieved one or more preferred locations of the consumer is then matched with a list of preferred locations of the service provider involved in the transaction at step 204. In case, if there is no match, the Match-Flag is set to 0 at step 210. The preferred locations of the service provider are then filtered based on set location proximity. This involves computing the distance between the preferred location of the service provider ‘X’ and the default location of the customer at step 212 and only selecting the preferred location with a distance less than the maximum configured distance for the consumer at step 214. The other preferred locations with a distance more than the maximum configured distance for the consumer are removed from the recommendation list at step 21. In the alternative, the one or more locations of the consumer matches with at least one preferred location from the list of preferred locations at step 206, then at least one matched preferred location is flagged as matched by setting Match-flag=1 at step 208. For each of the filtered preferred locations of the service provider, distance ‘Y’ between the preferred locations and the nearest preferred location of the consumer is computed at step 218. At step 220, the current shipping cost 7′ for each of the filtered preferred locations is retrieved. Then at step 222, the preferred locations of the service provider is sorted on chosen combination of one or more selected criteria that includes match-flag, distance ‘Y’ and shipping cost “7. This sorted list is then recommended to the consumer for delivering shipments at step 224.

In an exemplary embodiment, the transaction is between an affiliate store and an individual consumer, i.e. B2C transaction. The affiliate stores and the consumer are connected to the network and comprise a user profile. The profile of the consumers/individuals comprises one or more preferred locations frequently visited by them with one of them marked as the default location. The profile of the business entities/affiliate stores comprises a list of preferred locations to which they offer discounted shipping rates. When a consumer places an order through the network with the affiliate store, the processing unit 109 uses the steps detailed in FIG. 2 to recommend a possible list of cheaper shipping locations. Also, the user is provided with an option to browse the complete list of preferred locations of the affiliate store and manually choose any preferred location.

In an embodiment, the processing unit 109 also provides shipping discounts to the transacting user of the network 106 based on number of shipments on a specific date and time-slot to a preferred location of the affiliate store. The bulk-discount is based on the current shipments confirmed, can also be displayed to the user at the time of ordering.

In another exemplary embodiment, the transaction is between two individual consumers, i.e. C2C transaction. This transaction may involve sale of used goods etc. The profiles of the consumer/provider involved in the transaction comprise one or more locations frequently visited by them. In the case of user-to-user transactions, the profiles of the transacting parties are compared to arrive at optimal locations to exchange the transacted item. The processing unit 109 compares time and days of visit of each of the transacting user and provides a list of possible common locations, i.e. preferred locations for exchanging the transacted item. When there are more than one common preferred locations in the recommendation, the processing unit 109 sorts the result based on location proximity to the consumer of the transacted item. When there are no common preferred locations, the processing unit 109 recommends one or more possible popular locations from the public directory between the consumer and the provider to connect the transacting users. The recommendation might involve hopping between popular locations to connect the transacting users. In an exemplary embodiment, one or more affiliate logistics providers and members can publish their surplus shipping capacity between popular locations with details of date, time, capacity in terms of volume, weight and rate per capacity. The processing unit 109 then uses this data to recommend fastest and/or cheapest routes for transportation resulting from transactions between users. When a route is chosen, the processing unit 109 of the transaction server 102 prints the hops between popular locations in the form of a list that can be attached to the parcel. The preferred locations can also be bar-coded, and the printed list can use the bar-codes to enable automation of deliveries.

When a transaction involves sale of physical items and when the delivery is to a popular location, a barcode can be provided to capture the transaction number and popular destination location. The barcode can be printed and attached to the transacted items for easier tracking of items at the popular location. In an embodiment, on arrival of the transacted item at a popular location, the label can be scanned and the transaction status of corresponding shipment can be updated as delivered to the popular location. Also, optionally, a provision to accept a bin-number can be provided at the time of accepting a delivery, where the bin-number will indicate where the transacted item is stored until collected. A counter-receipt is made available to the consumer of items, which can be used to collect the item from a popular location. The counter-receipt can also have a barcode of the transaction, so that the collection process can be expedited, by displaying the bin-number of the parcel.

In an embodiment, if there is a door-delivery service to a location, the postcodes of addresses of all the transacted items to be delivered can be barcoded and scanned and used to arrive at a route planner for the door-to-door deliveries by the processing unit 109.

The method of the present disclosure provides for leveraging on surplus logistics services for dynamically finding a cheaper and greener route to courier transacted items. Similarly, surplus shipping and airline services can be leveraged to deliver cross-border parcels.

In an embodiment, the system of the present disclosure can be used to assist users connected to the network to find carpooling partners. The users have the option to search for carpool partners on the network for specified source and destination locations. The processing unit 109 of the transaction server 102 receives the request and compares with locations of other users connected to the network to recommend carpool partners based on predefined maximum deviation allowed and optionally maximum distance. The recommendations can be sorted based on location proximity and/or social-connectedness of the two users in the social-networking environment.

In an embodiment, the method of the present disclosure can also be extended for use by public transport service companies to allow people book their commuting needs in advance so as to help service providers provide right adjustment to frequency and capacity of commuting services.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Many variations of the invention and embodiments herein described will be apparent to people skilled in the art. For example, features of the different embodiments disclosed herein may be omitted, selected, combined or exchanged in order to form further embodiments. Again, where a preference or particularisation is stated, there is implicit the possibility of its negative, i.e. a case in which that preference or particularisation is absent. The invention is considered to extend to any new and inventive embodiments formed by said variations, further embodiments and cases, without deviation from scope of the invention.

The various aspects and embodiments disclosed herein are for purposes of illustration and are not intended to be limiting, with the true scope and spirit being indicated by the following claims.

### REFERRAL NUMERALS

| Reference | |
|---|---|
| number | Description |
| 100 | Distributed networking system |
| 102 | Transaction server |
| 104 | Client device |
| 106 | Network |
| 108 | Storage unit |
| 109 | Processing unit |
| 110 | User interface |

I/We claim:

1. A method for recommending one or more locations for shipping products to a consumer of a transaction in a distributed networking system, comprising:
retrieving one or more preferred locations of the consumer for shipping products, by a processing unit configured in the transaction server, from profile of the consumer stored in the storage unit; wherein the list of preferred locations are frequently visited locations of the consumer;
matching, by the processing unit, the retrieved preferred locations of the consumer with a list of preferred locations of the service provider of the transaction in the profile of the service provider.
recommending a filtered and sorted list of the preferred locations of the service provider, by the processing unit, for delivering shipments to the consumer, wherein filtering is based on a threshold location proximity defined by the system, and the sorting is based on at least one of (i) one or more preferred locations of the consumer matching the preferred locations of the service provider, (ii) distance between the preferred location of the service provider and the nearest preferred location of the consumer, and (iii) the cost of shipping to a preferred location of the service provider.

2. The method as claimed in claim 1, further comprising selecting a location as preferred location for shipping products by a user of the distributed networking from a public directory of popular locations stored in the storage unit of the transaction server.

3. The method as claimed in claim 1, wherein entries to the public directory of popular locations is made upon determining a predetermined number of users of the distributed networking system having same preferred location in their profile.

4. The method as claimed in claim 1 further comprising providing a discounted shipping rate by the service providers to locations in the directory of popular locations.

5. The method as claimed in claim 4, where the discounted shipping rate provided to the consumer for a location on a specific date and time is increased dynamically based on the number of confirmed shipments to the location received by the service provider on the specified date and time.

6. The method as claimed in claim 1, further comprising a method of recommending one or more popular or preferred locations by a user to the one or more other users of the distributed networking system.

7. The method as claimed in claim 1, wherein the preferred locations of a user comprises locations being frequently visited by the user and qualified by time and frequency of visit.

8. The method as claimed in claim 1, wherein the distributed networking system is an ecommerce system facilitating at least one of business-to-consumer and consumer- to-consumer transactions.

9. The method as claimed in claim 1, wherein the users of the distributed networking system can be at least one of individuals and business entities.

10. A distributed networking system for recommending one or more locations for shipping products to a consumer of a transaction, comprising:
a transaction server connected to a plurality of client devices over a network comprising:
a storage unit to store profile of one or more users;
a processing unit, in communication with the storage unit, configured to:
retrieve one or more preferred locations from profile of the consumer for shipping products;
match the retrieved preferred locations of the consumer with a list of preferred locations of the service provider of the transaction in the profile of the service provider, wherein the list of preferred locations are the frequently used location of the service provider; and
recommend a filtered and sorted list of the preferred locations of the service provider for delivering shipments to the consumer, wherein filtering is based on a threshold location proximity defined by the system, and the sorting is based at least one of the preferred locations of the consumer matching the preferred locations of the service provider, the distance between the preferred location of the service provider and the nearest preferred location of the consumer and cost of shipping to a preferred location of the service provider;
the plurality of client devices wherein each of the client device comprises a user interface to display the sorted list of preferred locations to the consumer.
